(19) United States
(12) Patent Application Publication
(10) Pub. No.: US 2015/0322221 A1
(43) Pub. Date: Nov. 12, 2015

(54) PATTERNED FILMS AND METHODS

(71) Applicant: Carestream Health, Inc., Rochester, NY (US)

(72) Inventors: Tryg R. Jensen, Roseville, MN (US); Erin R. Bell, Woodbury, MN (US); Christopher D. Emerson, St. Paul, MN (US)

(21) Appl. No.: 14/680,131

(22) Filed: Apr. 7, 2015

Related U.S. Application Data
(60) Provisional application No. 61/990,748, filed on May 9, 2014.

(51) Int. Cl. C08J 7/00

(52) U.S. Cl. CPC C08J 7/00; C08J 2371/08; C08J 2339/06

(57) ABSTRACT

A method for patterning a film, the film comprising conductive nanostructures dispersed in a matrix, the matrix comprising at least one first leachable compound, the method comprising leaching at least some of the at least one first leachable compound from the matrix to form at least one patterned region of the matrix, the at least one patterned region comprising at least some of the conductive nanostructures, where the film prior to leaching exhibits a first surface resistivity, a first total light transmittance, and a first percent haze, and the at least one patterned region exhibits a second surface resistivity that is less than the first surface resistivity.

### CROSS REFERENCE TO RELATED APPLICATIONS

This application claims the benefit of U.S. Provisional Application No. 61/990,748, filed May 9, 2014, entitled “PATTERNED FILMS AND METHODS,” which is hereby incorporated by reference in its entirety.

### BACKGROUND

Transparent conductive films are used in electronic applications, such as touch screen sensors for portable electronic devices. Transparent conductive films comprising silver nanowires are particularly well suited for such applications because of their flexibility, high conductivity, and high optical transparency.

For many electronic applications, such transparent conductive films are patterned in order to provide low resistivity regions separated by high resistivity regions. For commercial applications, the transparent conductor must have a patterned conductivity that can be produced in a low-cost, high-throughput process. Known methods of patterning involve creating etched regions and unetched regions in a film, where etched regions have higher resistivity or lower conductivity than unetched regions. (See, e.g., U.S. Pat. Appl. Pub. Nos. 2014/0021400 A1 and 2011/0253668 A1).

### SUMMARY

At least a first embodiment comprises a method for patterning a film, where the film comprises conductive nanostructures dispersed in a matrix, and the matrix comprises at least one first leachable compound, and the method comprises leaching at least some of the at least one first leachable compound from the matrix to form at least one patterned region of the matrix, where the at least one patterned region comprises at least some of the conductive nanostructures, and where the film prior to leaching exhibits a first surface resistivity, a first total light transmittance, and a first percent haze, and the at least one patterned region exhibits a second surface resistivity that is less than the first surface resistivity. In some cases, the conductive nanostructures comprise metal nanowires, such as, for example, silver nanowires.

In at least some such methods, the second surface resistivity is less than about 100 ohms/square, or less than about 20 ohms/square. In some cases, the first surface resistivity is greater than about 100 ohms/square, or greater than about 1000 ohms/square. In any of these methods, the ratio of the first surface resistivity to the second surface resistivity may be greater than about 1000.

In at least some such methods, the at least one patterned region exhibits a second total light transmittance, where the absolute value of the difference between the first total light transmittance and the second total light transmittance is less than about 5%, or less than about 1%.

In at least some such methods, the at least one patterned region exhibits a second percent haze, where the absolute value of the difference between the first percent haze and the second percent haze being less than about 5%, or less than about 1%

In at least some such methods, the leaching comprises contacting the film with at least one penetrant, and dissolving at least some of the at least one first leachable compound in, or reacting at least some of the first leachable compound with, the at least one penetrant, such as, for example, water or hydrochloric acid. In at least some cases, the at least one first leachable compound comprises at least one water soluble polymer, such as, for example, polyethylene glycol or poly polyvinylpyrrolidone. In at least some cases, the conductive structures do not readily dissolve in or react with the at least one penetrant.

In at least some such methods, the matrix further comprises at least one cellulose ester polymer, such as, for example, cellulose acetate butyrate.

At least a second embodiment provides the patterned films formed by any of these methods.

### DESCRIPTION OF FIGURES

FIG. 1 is a graph representing the relationship between surface resistivity and haze for transparent conductive films comprising silver nanowires having an average length of 30 nm. The top curve represents comparative samples Com-4-1 through Com-4-9, and the bottom curve represents leached samples 4-1 through 4-9.

FIG. 2 is a graph representing the relationship between surface resistivity and haze for transparent conductive films comprising silver nanowires having an average length of 40 nm. The top curve represents comparative samples Com-6-1 through Com-6-10, and the bottom curve represents leached samples 6-1 through 6-10.

FIG. 3 is a graph representing the relationship between surface resistivity and haze for transparent conductive films comprising silver nanowires having an average length of 90 nm. The top curve represents comparative samples Com-7-1 through Com-7-9, and the bottom curve represents leached samples 7-1 through 7-9.

### DESCRIPTION

All publications, patents, and patent documents referred to in this document are incorporated by reference herein in their entirety, as though individually incorporated by reference.

U.S. Provisional Application No. 61/990,748, filed May 9, 2014, entitled “PATTERNED FILMS AND METHODS,” is hereby incorporated by reference in its entirety.

In some applications, it may be desirable to pattern a film to produce patterned regions of different resistivity than unpatterned regions, where the patterning causes minimal, if any, change to the optical properties of the film (e.g. total light transmissivity and percent haze). Whereas previous patterning methods produce films that have patterned regions exhibiting lower conductivity than unpatterned regions, we employ a patterning method that produces films that have patterned regions exhibiting higher conductivity than unpatterned regions. Our patterning method has proven to produce regions of different conductivity while maintaining the optical properties of the film within desired ranges. In some cases, our patterned films have better optical properties, such as, for example, lower haze, than other patterned films produced through known patterning methods. We have further discovered that incorporation of a leachable compound into the conductive layer in which conductive structures are dispersed within a matrix facilitates our patterning method. This method can also be employed to pattern the entire film to increase the conductivity of the entire film without causing changes to the optical properties of the film outside desired ranges.

### Conductive Structures

The conductive structures can be formed from any conductive material. In some cases, conductive structures are made from a metallic material, such as elemental metal (e.g. transition metal) or a metal compound (e.g. metal oxide). The metallic material can also be a bimetallic material or metal alloy, which comprises two or more types of metal. Non-limiting examples of suitable metals include silver, gold, copper, nickel, gold-plated silver, platinum, and palladium.

Such conductive structures can be any shape or geometry, such as nanowires, particles, nanotubes, and nanorods. The conductive structures may be nano-sized structures (i.e. conductive nanostructures), where at least one dimension (e.g. diameter, length, or width) of the conductive structures is less than 500 nm, or in some cases, less than 100 nm or 50 nm. For example, silver nanowires may have diameter ranges of 10 nm to 120 nm, 25 nm to 35 nm, 30 to 33 nm, 35 nm to 45 nm, 55 nm to 65 nm, or 80 to 120 nm. Such silver nanowires may have average diameters of 30 nm, 40 nm, 60 nm, or 90 nm. Such silver nanowires may have lengths greater than 500 nm, 1 μm, or 10 μm.

Other non-limiting examples of conductive structures include nanowires, metal meshes, nanotubes (e.g. carbon nanotubes), conductive oxides (e.g. indium tin oxide), graphene, and conductive polymer fibers.

### Matrix

Matrix, which may also be referred to as binder or binders in some cases, refers to materials in which conductive structures (e.g. silver nanowires) are embedded or dispersed. The conductive structures and the matrix form the conductive layer disposed on a substrate that makes up the film. The matrix may provide structural integrity to the conductive layer.

In some embodiments, the matrix comprises an optically clear or optically transparent material. In this application, “optically clear” or “optically transparent” means that light transmission of the material in the visible region (approximately 400 nm to 700 nm) (referred to in this application as “total light transmittance”) is at least 80%. A polymer may be an optically clear or optically transparent material. Some optically clear or optically transparent materials comprise polymers, such as, for example, cellulosic polymers, such as cellulose esters, including, for example, cellulose acetate polymers, which include, for example, cellulose acetate butyrate.

### Leachable Compound

A conductive layer may comprise at least one leachable compound within the matrix. The leachable compound may coat the conductive structures or prevent conductive structures from contacting or electrically coupling with each other, for example, by capacitive or inductive coupling. The leachable compound is removable from the matrix through dissolution or the combined effect of chemical reaction and dissolution.

Generally, the leachable compound should have different dissolution or solubility characteristics than at least some of the matrix material to prevent the matrix from completely dissolving when the leachable compound is leached away in the presence of a suitable penetrant. In some embodiments, the leachable compound may be a water soluble substance. The water soluble substance may directly (i.e. water soluble) or indirectly (through intermediate chemical reaction(s)) dissolve in an aqueous solution. Characteristics of a water soluble substance may include relatively high degree of polarity or hydrophilicity. The water soluble substance may comprise a water soluble polymer. Non-limiting examples of water soluble polymers include polyethylene glycol and polyvinylpyrrolidone.

### Patterning by Leaching

At least some embodiments provide a method of patterning a film comprising leaching at least some of a leachable compound from the matrix to form at least one patterned region in the matrix, where the patterned region comprises at least some of the conductive nanostructures.

Leaching is understood to mean the removal of a soluble fraction from an insoluble, permeable solid with which it is associated. The mechanism of leaching may, in some cases, involve simple physical dissolution, but it may also, in other cases, be facilitated by one or more chemical reactions. With respect to this application, particularly useful leaching methods do not significantly remove or substantially chemically modify the conductive nanostructures, but instead act principally on one or more leachable compounds in the matrix.

### Penetrants

In at least some such methods, the leaching comprises contacting the film with at least one penetrant, and dissolving at least some of the at least one first leachable compound in, or reacting at least some of the first leachable compound with, the at least one penetrant. A penetrant may be a solvent or a reactant that acts to leach at least some of the first leachable compound from the matrix. For example, water and hydrochloric acid are exemplary penetrants, which may be used to leach water soluble compounds.

### Electrical Properties

The leaching patterning methods of the present application can be used to create a patterned region without substantial damage or removal of conductive structures in the patterned region. A beneficial result of the patterning is that the electrical conductivity increases in the patterned region relative to the unpatterned film. In some embodiments, the surface resistivity of the patterned region can less than about 100 ohms/square, or less than about 20 ohms/square. By contrast, the surface resistivity of the unpatterned film may be greater than about 100 ohms/square, or greater than about 1000 ohms/square. As a result, the ratio of the surface resistivity of the unpatterned film to the surface resistivity of the patterned region may be greater than about 1000.

### Optical Properties

The leaching patterning methods of the present application have the advantage that an optically clear conductive layer can be patterned to increase electrical conductivity while maintaining the optical properties of the patterned region relative to the unpatterned film. As shown, for example, in Examples 2-6, the change in optical properties, including total light transmittance (%) and percent haze (%) was relatively small comparing a region before and after it was patterned or comparing a patterned region with an unpatterned region, such that the resulting patterns are substantially invisible. A conductive layer being substantially invisible means that it appears optically uniform in appearance to the unaided eye. In some embodiments, the difference in total light transmittance (%) and/or percent haze (%) between a region before and after it was patterned or between an patterned region and the unpatterned portions of the film is less than 10%, or less than 5%, or less than 1%.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the claims that will issue from applications claiming benefit of this provisional application, and all changes that come within the meaning and range of equivalents thereof are intended to be embraced therein.

### Exemplary Embodiments

U.S. Provisional Application No. 61/990,748, filed May 9, 2014, entitled “PATTERNED FILMS AND METHODS,” which is hereby incorporated by reference in its entirety, disclosed the following 22 non-limiting exemplary embodiments:
A. A method for patterning a film, the film comprising conductive nanostructures dispersed in a matrix, the matrix comprising at least one first leachable compound, the method comprising:

leaching at least some of the at least one first leachable compound from the matrix to form at least one patterned region of the matrix, the at least one patterned region comprising at least some of the conductive nanostructures,

wherein the film prior to leaching exhibits a first surface resistivity, a first total light transmittance, and a first percent haze, and the at least one patterned region exhibits a second surface resistivity that is less than the first surface resistivity.
B. The method according to embodiment A, wherein the conductive nanostructures comprise metal nanowires.
C. The method according to either of embodiments A or B, wherein the conductive structures comprise silver nanowires.
D. The method according to any of embodiments A-C, wherein the second surface resistivity is less than about 100 ohms/square.
E. The method according to any of embodiments A-D, wherein the second surface resistivity is less than about 20 ohms/square.
F. The method according to any of embodiments A-E, wherein the first surface resistivity is greater than about 100 ohms/square.
G. The method according to any of embodiments A-F, wherein the first surface resistivity is greater than about 1000 ohms/square
H. The method according to any of embodiments A-G, wherein the ratio of the first surface resistivity to the second surface resistivity is greater than about 1000.
J. The method according to any of embodiments A-H, wherein the at least one patterned region exhibits a second total light transmittance, the absolute value of the difference between the first total light transmittance and the second total light transmittance being less than about 5%.
K. The method according to any of embodiments A-J, wherein the at least one patterned region exhibits a second total light transmittance, the absolute value of the difference between the first total light transmittance and the second total light transmittance being less than about 1%.
L. The method according to any of embodiments A-K, wherein the at least one patterned region exhibits a second percent haze, the absolute value of the difference between the first percent haze and the second percent haze being less than about 5%.
M. The method according to any of embodiments A-L, wherein the at least one patterned region exhibits a second percent haze, the absolute value of the difference between the first percent haze and the second percent haze being less than about 1%.
N. The method according to any of embodiments A-M, wherein the leaching comprises:

contacting the film with at least one penetrant; and

dissolving at least some of the at least one first leachable compound in, or reacting at least some of the first leachable compound with, the at least one penetrant.
P. The method according to embodiment N, wherein the at least one penetrant comprises water.
Q. The method according to either of embodiments N or P, wherein at least one penetrant comprises hydrochloric acid.
R. The method according to any of embodiments N-Q, wherein the at least one first leachable compound comprises at least one water soluble polymer.
S. The method according to embodiment R, wherein the water soluble polymer comprises polyethylene glycol.
T. The method according to either of embodiments R or S, wherein the water soluble polymer comprises polyvinylpyrrolidone.
U. The method according to any of embodiments N-T, wherein the conductive structures do not readily dissolve in or react with the at least one penetrant.
V. The method according to any of embodiments A-U, wherein the matrix further comprises at least one cellulose ester polymer.
W. The method according to embodiment V, wherein the at least one cellulose ester polymer comprises cellulose acetate butyrate.
X. A patterned film formed by the methods according to any of embodiments A-W.

### EXAMPLES

### Materials

All materials used in the following examples are readily available from standard commercial sources, such as Sigma-Aldrich Co. LLC. (St. Louis, Mo.) unless otherwise specified.

Polyethylene glycol is available through Sigma-Aldrich Co. LLC. (St. Louis, Mo.) as KOLLISOLV® PEG E 300. It is has a weight average molecular weight of 285-315 g/mol (from OH-value (56100*2)/OHZ).

CAB 381-20 is a cellulose acetate butyrate resin available from Eastman Chemical Co. (Kingsport, Tenn.). It has a glass transition temperature of 141° C.

CAB 553-0.4 is a cellulose acetate butyrate resin available from Eastman Chemical Co. (Kingsport, Tenn.). It has a glass transition temperature of 136° C.

XCURE 184 is a 1-hydroxycyclohexylphenyl ketone photoinitiator. (Dalian Xueyuan Specialty Chemical Ltd.).

n-propyl acetate is available from Oxea Corp.

Isopropanol (“IPA”) and ethyl lactate (>99.8% purity) are available from Sigma-Aldrich Co. LLC (St. Louis, Mo.).

PMT is 1-phenyl-1H-tetrazole-5-thiol, available from Columbia Organic Chemicals (Columbia, S.C.). Its structure is shown below:

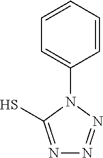 [SMILES: Sc1nnnn1-c1ccccc1]

Phthalic acid is available from Sigma-Aldrich Co. LLC. (St. Louis, Mo.).

SLIP-AYD® FS 444 (polysiloxane in dipropylene glycol, Elementis) is a liquid additive for increasing surface slip and mar resistance of water borne and polar solvent borne coatings.

SR399 (dipentaerythritolpentaacrylate, Sartomer) is a clear liquid, with a molecular weight of 525 g/mol; its structure is shown below:

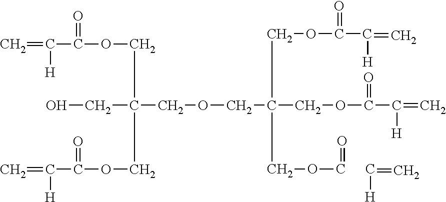

5 mil ESTAR® LS (low shrinkage) polyester support is available from Eastman Kodak Co. (Rochester, N.Y.).

### Instruments

Percent haze and total light transmittance were measured using a BYK-Gardner Haze-Gard haze meter. Surface resistivity was measured immediately after coating using either an RCHEK RC2175 four point resistivity meter or a DELCOM 707 non-contact conductance monitor.

### Example 1

### Silver Nanowires

Silver nanowires having approximate diameters of 33 nm and approximate lengths of 15 micrometers were used in this Example.

### Preparation of Silver Nanowire Coated Substrates

A CAB polymer premix solution was prepared by mixing 10 parts by weight of CAB 381-20 with 90 parts by weight of n-propyl acetate to form a solution of 10% CAB 381-20.

5.55 parts by weight of the CAB polymer premix solution was combined with 2.24 parts by weight ethyl lactate, 10 parts by weight of a 1.85% solids dispersion of silver nanowires in isopropanol, and 2.3 parts by weight of n-propyl acetate to form a silver nanowire coating dispersion of 3.30% solids by weight.

The finished silver nanowire dispersion was coated onto a polyester support on a lab proofer with a 420 line per inch plate and then dried at 140° C. for 1 minute.

### Preparation of Topcoat Solutions

A CAB polymer premix solution was prepared by mixing 790.91 parts by weight of CAB 553-0.4 into 2240.9 parts by weight of denatured ethanol and 2240.9 parts by weight of methanol to form a solution of 15.0% CAB 553-0.4 by weight.

A topcoat solution was prepared by adding to 5272.71 parts by weight of the CAB polymer premix solution, 2373 parts by weight of Sartomer SR399, 15 parts by weight of Slip-Ayd FS-444, 58 parts by weight of PMT, 88 parts by weight of phthalic acid, 263.6 parts by weight of XCURE 184, 4482 parts by weight of methanol, and 15090.4 parts by weight of denatured ethanol. The top solution was 14.1% solids by weight. The topcoat solution were coated onto a silver nanowire coated substrate using a lab proofer with a 450 line per inch plate, dried at 110° C. for 30 seconds, passed through a H-bulb equipped UV cure station twice at 20 ft/min.

### Evaluation of Coatings

Eddy current readings and light transmission and haze measurements were taken for silver nanowire coated substrates with and without top coats prior to being dipped in a 15% aqueous hydrochloric solution and after being dipped in 15% aqueous hydrochloric solution, rinsed, and dried.

For each of the two samples of silver nanowire coated substrate with a top coat, they had complete electrical resistivity (i.e. 1000 divided by the eddy current reading) as calculated based on the eddy current readings of 0 mMhos, total light transmittance of 90%, and haze of 0.9% prior to being dipped in a 15% aqueous hydrochloric solution, as shown in TABLE IA. The data suggests that a resistive film of desired optical properties (e.g. total light transmittance and haze) can be made.

TABLE IA

| | Total Light | | Surface |
|---|---|---|---|
| | Transmittance | Haze | Resistivity |
| Sample | (percent) | (percent) | (ohms/sq) |
| 1-1 | 90 | 0.9 | ∞ |
| 1-2 | 90 | 0.9 | ∞ |

For the sample of silver nanowire coated substrate without a top coat, it had complete electrical resistivity (i.e. 1000 divided by the eddy current reading) as calculated based on the eddy current reading of 0 mMhos, total light transmittance of 90%, and haze of 1.0% prior to being dipped in a 15% aqueous hydrochloric solution and an electrical resistivity of 71 ohms (i.e. 1000 divided by eddy current reading) as calculated based on the eddy current reading of 14 mMhos, total light transmittance of 90%, and haze of 0.9% after being dipped in a 15% aqueous hydrochloric solution, as shown in TABLE IB. The data suggests that a resistive film can be made conductive while maintaining the optical properties of the film within the desired range.

TABLE IB

| | Total Light | | Electrical |
|---|---|---|---|
| | Transmittance | Haze | Resistance |
| | (percent) | (percent) | (ohms) |
| Before Dip into | 90 | 1.0 | ∞ |
| 15% Aqueous | | | |
| Hydrochloric | | | |
| Acid Solution | | | |
| After Dip into | 90 | 0.9 | 71 |
| 15% Aqueous | | | |
| Hydrochloric | | | |
| Acid Solution | | | |

### Example 2

The silver nanowire coating dispersion was prepared as described in Example 1 and used to prepare several silver nanowire coating dispersion samples containing varying amounts of polyethylene glycol. The amount of polyethylene glycol was increased with each sample until the coated layer became resistive. The finished silver nanowire dispersion was coated onto a polyester support on a lab proofer with a 420 line per inch plate and then dried at 140° C. for 1 minute. For each sample, electrical resistivity was calculated from eddy current readings (i.e. 1000 divided by the eddy current reading) and total light transmittance and haze measurements were recorded, which are shown in TABLE II. The data suggests that the addition of polyethylene glycol can produce a complete resistive film while maintaining the optical properties of the film within the desired range.

TABLE II

| | Ratio of PEG | Total Light | | Surface |
|---|---|---|---|---|
| | to AgNW | Transmittance | Haze | Resistivity |
| Sample | (w/w) | (percent) | (percent) | (ohms/sq) |
| 2-1 | 0 | 89.8 | 1.23 | 68 |
| 2-2 | 0.334 | 89.8 | 1.24 | 74 |
| 2-3 | 0.578 | 89.8 | 1.24 | 111 |
| 2-4 | 0.851 | 89.4 | 1.23 | 256 |
| 2-5 | 1.167 | 89.8 | 1.21 | 1667 |
| 2-6 | 2.523 | 90 | 1.21 | ∞ |

### Example 3

The silver nanowire coating dispersion was prepared as described in Example 1 and used to prepare several silver nanowire coating dispersion samples containing varying amounts of polyvinylpyrrolidone. The amount of polyvinylpyrrolidone was increased with each sample until the coated layer became resistive. The finished silver nanowire dispersion was coated onto a polyester support on a lab proofer with a 420 line per inch plate and then dried at 140° C. for 1 minute. For each sample, electrical resistivities calculated from eddy current readings (i.e. 1000 divided by the eddy current reading) and total light transmittance and haze measurements were recorded for each sample, which are shown in TABLE III. The data suggests that the addition of polyvinylpyrrolidone can produce a complete resistive film while maintaining the optical properties of the film within the desired range.

TABLE III

| | Ratio of PVP | Total Light | | Surface |
|---|---|---|---|---|
| | to AgNW | Transmittance | Haze | Resistivity |
| Sample | (w/w) | (percent) | (percent) | (ohms/sq) |
| 3-1 | 0 | 89.3 | 1.16 | 71 |
| 3-2 | 0.607 | 89.9 | 1.08 | 81 |
| 3-3 | 1.215 | 90.3 | 1.07 | 110 |
| 3-4 | 1.822 | 89.9 | 1.01 | 286 |
| 3-5 | 4.859 | 91 | 0.88 | ∞ |

### Example 4

Silver nanowires having approximate diameter range of 25 nm to 35 nm with an approximate average diameter of 30 to 33 nm were used in this Example. The silver nanowire coating dispersion was prepared in a manner similar to that described in Example 1, except diluted 20% by using CAB 381-20, ethyl lactate, n-propyl acetate, isopropanol. The 20% dilution aided in a less thick coating dispersion that was easier to work or coat with. Polyethylene glycol was added to the coating dispersion at a ratio of 1.11 parts by weight to about 9.83 parts by weight of the coating dispersion and agitated for about 30 minutes.

Two sets of coated samples were prepared by varying the number of coatings (e.g. 1-6 coatings) on a support and using different plates having various lines per inch (e.g. 380, 420, or 450 line per inch) on a lab proofer. In general, decreasing the lines per square inch resulted in more coating material being applied to the support. For multiple coatings on a single support, the support was coated and air dried for about 1 minute prior to adding another coating. After all coatings were applied for a single support, the coated support was dried at 275° F. for two minutes. All samples were prepared by coating on a 5 mil ESTAR® LS base.

The first set of samples did not contain polyethylene glycol. Each of the first set of samples served as the control or comparative samples. For the first set of samples, the haze and surface resistivity measurements were recorded without the samples having been patterned.

For the second set of samples, each was dipped into a 10% aqueous hydrochloric acid solution, rinsed, and dried. After being dipped, surface resistivity, total light transmittance, and haze measurements were recorded for each sample. Surface resistivity measurements were obtained from an RCHEK™ Surface Resistivity Meter.

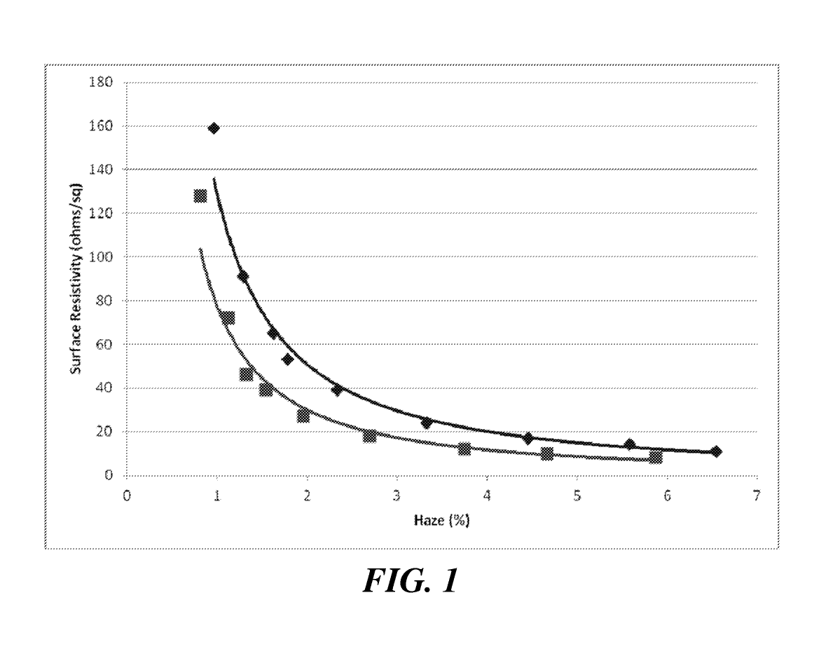

The results for both the first and second set of samples are shown in TABLE IV. Curves of surface resistivity versus haze for the first set of samples (“control” or “comparative” samples) and the second set of samples (“leached” samples) were generated and are depicted in FIG. 1. The curves were based on silver nanowires having an average diameter of 33 nm. T As shown in FIG. 1, the leached curve is shifted to the left or down relative to the control curve, suggesting that at a given resistivity, the haze was decreased, which is more desirable for the purposes in this application.

TABLE IV

| | | Plate | | | |
|---|---|---|---|---|---|
| | Number | (lines | Total Light | | Surface |
| | of | per | Transmittance | Haze | Resistivity |
| Sample | Coatings | inch) | (percent) | (percent) | (ohms/sq) |
| Com-4-1 | 1 | 420 | 90.4 | 1.29 | 91 |
| 4-1 | 1 | 420 | 90.4 | 1.12 | 72 |
| Com-4-2 | 2 | 420 | 90.9 | 2.33 | 39 |
| 4-2 | 2 | 420 | 91.3 | 1.96 | 27 |
| Com-4-3 | 3 | 420 | 87.7 | 3.33 | 24 |
| 4-3 | 3 | 420 | 88.6 | 2.69 | 18 |
| Com-4-4 | 4 | 420 | 86.0 | 4.45 | 17 |
| 4-4 | 4 | 420 | 85.6 | 3.74 | 12 |
| Com-4-5 | 5 | 420 | 85.9 | 5.58 | 14 |
| 4-5 | 5 | 420 | 85.9 | 4.66 | 10 |
| Com-4-6 | 6 | 420 | 84.8 | 6.54 | 11 |
| 4-6 | 6 | 420 | 85.1 | 5.87 | 8 |
| Com-4-7 | 1 | 450 | 90.1 | 0.96 | 159 |
| 4-7 | 1 | 450 | 90.1 | 0.81 | 128 |
| Com-4-8 | 2 | 450 | 91.1 | 1.78 | 53 |
| 4-8 | 2 | 450 | 91.1 | 1.54 | 39 |
| Com-4-9 | 1 | 380 | 91.0 | 1.62 | 65 |
| 4-9 | 1 | 380 | 91.2 | 1.32 | 46 |

### Example 5

### Comparative

Silver nanowires having approximate diameter range of 25 nm to 35 nm with an approximate average diameter of 30 to 33 nm were used in this Example. The silver nanowire coating dispersion was prepared in a manner similar to that described in Example 1. No leachable compound was added to the silver nanowire coating dispersion. Two samples were prepared by coating two supports each with a single coating of the silver nanowire coating dispersion using a lap proofer with a 420 LPI plate. The total light transmittance, haze, average eddy current, and resistivity of both samples were recorded before and after the samples were etched with a 10% aqueous solution of hydrochloric acid, as shown in TABLE V. In contrast to previous examples with the presence of a leachable compound in the samples, there does not appear to be the change in resistivity as observed in the previous examples. The data suggests that the presence of a leachable compound may be a significant contributor to the shifting of the leached curve, as observed, for example, in Example 4.

TABLE V

| | | | | Average | |
|---|---|---|---|---|---|
| | | Total Light | | Eddy | Surface |
| | | Transmittance | Haze | Current | Resistivity |
| | Sample | (percent) | (percent) | (mMhos) | (ohms/sq) |
| Before | Com-5-1 | 89.9 | 1.27 | 19.20 | 52.08 |
| Etching | Com-5-2 | 89.9 | 1.27 | 18.90 | 52.91 |
| After | Com-5-1 | 89.9 | 1.25 | 19.15 | 52.22 |
| Etching | Com-5-2 | 89.9 | 1.24 | 18.83 | 53.11 |

### Example 6

Silver nanowires having approximate range of diameter of 35 nm to 45 nm with an approximate average diameter of 40 nm were used in this Example. A silver nanowire coating dispersion was prepared from 5 parts by weight of a 1.85% solution of silver nanowire in isopropanol, 0.73 parts by weight of n-propyl acetate, 1.66 parts by weight of ethyl lactate, and 7.44 parts by weight of CAB 381-20 as a 5.0% weight solution in n-propyl acetate, and 0.87 parts by weight of polyethylene and agitated for about 30 minutes. The ratio of polyethylene glycol to coating dispersion was about 0.87 parts by weight to about 14.82 parts by weight.

Two sets of coated samples were prepared by varying the number of coatings (e.g. 1-6 coatings) on a support and using different plates having different lines per inch (e.g. 380, 420, or 450 line per inch) on a lab proofer. In general, decreasing the lines per square inch resulted in more coating material being applied to the support. For multiple coatings on a single support, the support was coated and air dried for about 1 minute prior to adding another coating. After all coatings were applied for a single support, the coated support was dried at 275° F. for two minutes. All samples were prepared by coating on a 5 mil ESTAR® LS base.

The first set of samples did not contain polyethylene glycol. Each of the first set of samples serves as the control or comparative samples. For the first set of samples, the haze and surface resistivity measurements were recorded without the samples having been patterned.

For the second set of samples, each was dipped into a 10% aqueous hydrochloric acid solution, rinsed, and dried. After being dipped, surface resistivity, total light transmittance, and haze measurements were recorded for each sample. Surface resistivity measurements were obtained from an RCHEK™ Surface Resistivity Meter.

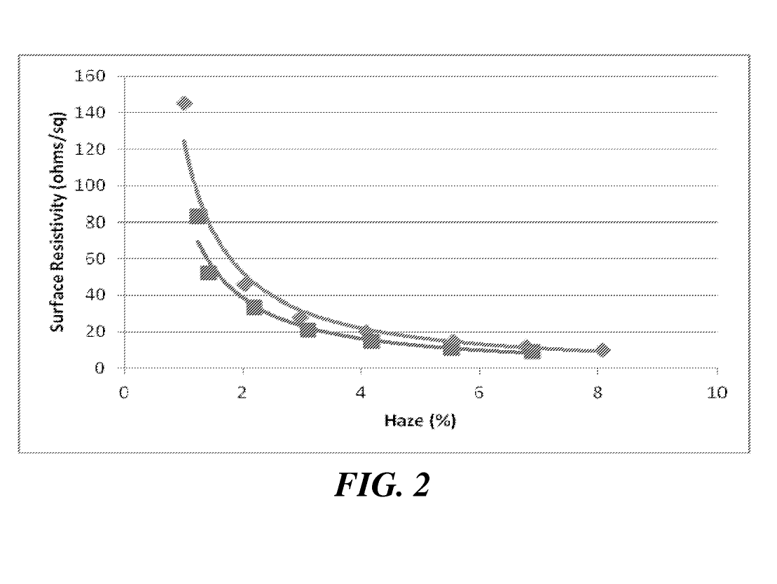

The results for both the first and second set of samples are shown in TABLE VI. Curves of surface resistivity versus haze for the first set of samples (“control” or “comparative” samples) and the second set of samples (“leached” samples) were generated and are depicted in FIG. 2. The curves were based on silver nanowires having an average diameter of 40 nm. To better focus on the curves, comparative samples 1-7 were excluded from the “control” curve, and samples 1-7 through 1-10 were excluded from the “leached” curve. As shown in FIG. 2, the leached curve is shifted to the left or down relative to the control curve, suggesting that at a given resistivity, the haze is less, which is more desirable for the purposes in this application.

TABLE VI

| | | Plate | | | |
|---|---|---|---|---|---|
| | Number | (lines | Total Light | | Surface |
| | of | per | Transmittance | Haze | Resistivity |
| Sample | Coatings | inch) | (percent) | (percent) | (ohms/sq) |
| Com-6-1 | 1 | 420 | 89.9 | 1.00 | 145 |
| 6-1 | 1 | 420 | 90.0 | 1.24 | 83 |
| Com-6-2 | 2 | 420 | 90.8 | 2.02 | 46 |
| 6-2 | 2 | 420 | 90.9 | 2.19 | 33 |
| Com-6-3 | 3 | 420 | 88.8 | 2.97 | 28 |
| 6-3 | 3 | 420 | 88.3 | 3.10 | 21 |
| Com-6-4 | 4 | 420 | 85.8 | 4.09 | 20 |
| 6-4 | 4 | 420 | 85.1 | 4.16 | 15 |
| Com-6-5 | 5 | 420 | 85.1 | 5.55 | 15 |
| 6-5 | 5 | 420 | 85.1 | 6.88 | 11 |
| Com-6-6 | 6 | 420 | 83.0 | 8.06 | 10 |
| 6-6 | 6 | 420 | 84.7 | 6.88 | 9 |
| Com-6-7 | 6 | 420 | 84.9 | 6.78 | 12 |
| 6-7 | 6 | 420 | — | — | — |
| Com-6-8 | 1 | 450 | 89.7 | 0.72 | 353 |
| 6-8 | 1 | 450 | 89.6 | 0.89 | 221 |
| Com-6-9 | 2 | 450 | 90.5 | 1.32 | 88 |
| 6-9 | 2 | 450 | 90.7 | 1.60 | 55 |
| Com-6-10 | 1 | 380 | 90.4 | 1.36 | 68 |
| 6-10 | 1 | 380 | 90.6 | 1.42 | 52 |

### Example 7

Silver nanowires having approximate range of diameter of 80 nm to 120 nm with an approximate average diameter of 90 nm were used in this Example. A silver nanowire coating dispersion was prepared from 6.50 parts by weight of a 1.85% solution of silver nanowire in isopropanol, 0.55 parts by weight of n-propyl acetate, 7.55 parts by weight of ethyl lactate, 6.64 parts by weight of CAB 381-20 as a 10% weight solution in n-propyl acetate, 5.28 parts by weight of isopropanol, and 1.91 parts by weight of polyethylene glycol and agitated for about 30 minutes. The ratio of polyethylene glycol to coating dispersion was about 1.91 parts by weight to about 25.97 parts by weight.

Two sets of coated samples were prepared by varying the number of coatings (e.g. 3-9 coatings) on a support and using either a 320 line per inch plate or 450 line per inch plate on a lab proofer. In general, decreasing the lines per square inch resulted in more coating material being applied to the support. For multiple coatings on a single support, the support was coated and air dried for about 1 minute prior to adding another coating. After all coatings had been applied for a single support, the coated support was dried at 275° F. for two minutes. All samples were prepared by coating on a 5 mil ESTAR® LS base.

The first set of samples did not contain polyethylene glycol. Each of the first set of samples served as the control or comparative samples. For the first set of samples, the haze and surface resistivity measurements were recorded without the samples having been treated.

For the second set of samples, each was dipped into a 10% aqueous hydrochloric acid solution, rinsed, and dried. After being dipped, surface resistivity, total light transmittance, and haze measurements were recorded for each sample. Surface resistivity measurements were obtained from an RCHEK™ Surface Resistivity Meter.

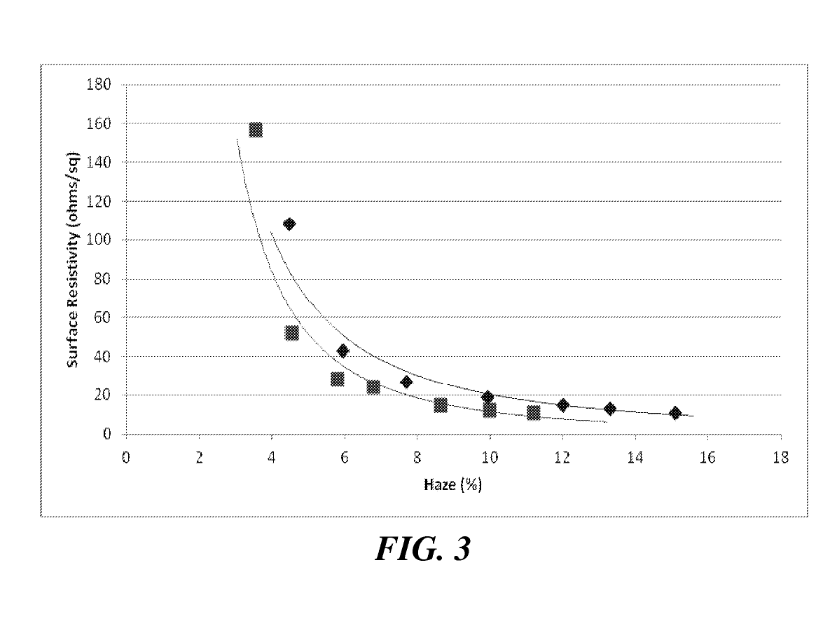

The results for both the first and second set of samples are shown in TABLE VII. Curves of surface resistivity versus haze for the first set of samples (“control” or “comparative” samples) and the second set of samples (“leached” samples) were generated and are depicted in FIG. 3. The curves were based on silver nanowires having an average diameter of 90 nm. As shown in FIG. 3, the leached curve is shifted to the left or down relative to the control curve, suggesting that at a given resistivity, the haze is less, which is more desirable for the purposes in this application.

TABLE VII

| | Number | Total Light | | Surface |
|---|---|---|---|---|
| | of | Transmittance | Haze | Resistivity |
| Sample | Coatings | (percent) | (percent) | (ohms/sq) |
| Com-7-1 | 3 | 89.9 | 4.47 | 108 |
| 7-1 | 3 | 90.3 | 3.54 | 157 |
| Com-7-2 | 4 | 88.5 | 5.96 | 43 |
| 7-2 | 4 | 89.1 | 4.54 | 52 |
| Com-7-3 | 5 | 86.0 | 7.70 | 27 |
| 7-3 | 5 | 86.9 | 5.80 | 28 |
| Com-7-4 | 6 | 84.2 | 9.93 | 19 |
| 7-4 | 6 | 85.5 | 6.80 | 24 |
| Com-7-5 | 7 | 83.4 | 12.00 | 15 |
| 7-5 | 7 | 84.9 | 8.63 | 15 |
| Com-7-6 | 8 | 83.1 | 13.30 | 13 |
| 7-6 | 8 | 84.9 | 10.00 | 12 |
| Com-7-7 | 9 | 82.0 | 15.10 | 11 |
| 7-7 | 9 | 84.4 | 11.20 | 11 |

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims, and all changes that come within the meaning and range of equivalents thereof are intended to be embraced therein.

What is claimed:

1. A method for patterning a film, the film comprising conductive nanostructures dispersed in a matrix, the matrix comprising at least one first leachable compound, the method comprising:
leaching at least some of the at least one first leachable compound from the matrix to form at least one patterned region of the matrix, the at least one patterned region comprising at least some of the conductive nanostructures,
wherein the film prior to leaching exhibits a first surface resistivity, a first total light transmittance, and a first percent haze, and the at least one patterned region exhibits a second surface resistivity that is less than the first surface resistivity.

2. The method according to claim 1, wherein the conductive nanostructures comprise metal nanowires.

3. The method according to claim 1, wherein the conductive structures comprise silver nanowires.

4. The method according to claim 1, wherein the second surface resistivity is less than about 100 ohms/square.

5. The method according to claim 1, wherein the first surface resistivity is greater than about 1000 ohms/square.

6. The method according to claim 1, wherein the ratio of the first surface resistivity to the second surface resistivity is greater than about 1000.

7. The method according to claim 1, wherein the at least one patterned region exhibits a second total light transmittance, the absolute value of the difference between the first total light transmittance and the second total light transmittance being less than about 5%.

8. The method according to claim 1, wherein the at least one patterned region exhibits a second total light transmittance, the absolute value of the difference between the first total light transmittance and the second total light transmittance being less than about 1%.

9. The method according to claim 1, wherein the at least one patterned region exhibits a second percent haze, the absolute value of the difference between the first percent haze and the second percent haze being less than about 5%.

10. The method according to claim 1, wherein the at least one patterned region exhibits a second percent haze, the absolute value of the difference between the first percent haze and the second percent haze being less than about 1%.

11. The method according to claim 1, wherein the leaching comprises:
contacting the film with at least one penetrant; and
dissolving at least some of the at least one first leachable compound in, or reacting at least some of the first leachable compound with, the at least one penetrant.

12. The method according to claim 11, wherein the at least one penetrant comprises water.

13. The method according to claim 11, wherein at least one penetrant comprises hydrochloric acid.

14. The method according to claim 11, wherein the at least one first leachable compound comprises at least one water soluble polymer.

15. The method according to claim 14, wherein the water soluble polymer comprises polyethylene glycol.

16. The method according to claim 14, wherein the water soluble polymer comprises polyvinylpyrrolidone.

17. The method according to claim 11, wherein the conductive structures do not readily dissolve in or react with the at least one penetrant.

18. The method according to claim 11, wherein the matrix further comprises at least one cellulose ester polymer.

19. The method according to claim 18, wherein the at least one cellulose ester polymer comprises cellulose acetate butyrate.

20. A patterned film formed by the methods according to claim 1.
